(19) United States
(12) Patent Application Publication
(10) Pub. No.: US 2019/0070745 A1
(43) Pub. Date: Mar. 7, 2019

(54) GUIDE FOR USE WITH HANDHELD SAW

(71) Applicant: Michael Andre Lovato, Laramie, WY (US)

(72) Inventor: Michael Andre Lovato, Laramie, WY (US)

(21) Appl. No.: 15/693,592

(22) Filed: Sep. 1, 2017

(51) Int. Cl. B27B 9/04; B27B 19/09; B27B 19/00

(52) U.S. Cl. CPC B27B 9/04; B27B 19/002; B27B 19/09

(57) ABSTRACT

A guide for use with a saw includes an attachment mechanism and a guide pin. The attachment mechanism removably attaches the guide to a back edge of a baseplate of the saw. The guide attaches to the baseplate proximate a cut made in the material when the saw is operated to make a cut in material. The guide is removable from the baseplate when not in use. The guide pin is movably or removably affixed to the attachment feature and extends into an area under the plane of the baseplate when the attachment feature of the guide is attached to the baseplate of the saw. The guide pin is configured to be in a plane of the blade and extend at least partially into the cut in the material made by the blade of the saw.

### FIELD

This disclosure relates generally to guide apparatuses for use with portable and/or handheld power saws.

### BACKGROUND

A saw is a tool that includes a blade and/or teeth for cutting a piece of material. The blade and/or teeth are moved across or through the material in order to repeatedly remove small portions of the material. The successive removal of the small portions of the material results in the forming of a cut in the material. In some cases, saws may also use other mechanisms for cutting the material including: a thin wire, a chain, a high-pressure stream of water or air, an abrasive slurry, and/or another element for removing portions of the material. Different types of blades, blade materials, blade constructions, tooth designs, tooth pitches, and/or blade speeds may be used depending on the material being cut. Saws may be used to cut wood, lumber, plastics, polymers, wafer board, fiberboard, engineered materials, synthetic materials, metals, natural materials, stone, concrete, and/or other materials.

While some saws are manually operated, a majority of saws utilize electrically or mechanically provided power to reduce the physical effort required by the user and/or increase the speed at which cuts can be made. These saws are commonly referred to as power saws. One large category of power saws are handheld power saws, such as circular saws, jigsaws, and reciprocating saws. These types of saws are very popular for construction and remodeling activities where a user is often moving around to do work in different places and/or on structures that are already in place.

Handheld power saws may be powered from an external electrical source to which a cord of the handheld power saw is attached. In other examples, the handheld power saw may include its own rechargeable or replaceable power source, such as a rechargeable battery or fuel cell. While many of the examples herein are discussed with respect to a circular saw, it should be understood that the apparatuses, improvements, and techniques disclosed herein are also applicable to other type of power saws, handheld saws, and/or portable saws.

One of the benefits of handheld power saws is the flexibility with which material can be cut in place without having to place the material into a frame, into a guide, into a vise, in a jig, or onto a platform or table of a non-handheld saw. One additional benefit is that handheld saws are often used to make freeform cuts where the user guides the saw through the material along a path he or she chooses. While these benefits are useful in number of circumstances, they also present challenges for the user. One challenge is the fact that a user often wishes to make a straight cut through the material even through the handheld saw being used may offer further flexibility to make curved or freeform cuts. In construction and remodeling activities, straight cuts are very common and are frequently desired. In the context of this disclosure, the term ‘straight cut’ is used to refer to a cut that is substantially linear from a starting point to a finishing end of the cut. The term does not require that the cut is any particular angle with respect to an edge of the material. In other words, a straight cut may be a cut that is made at a non-90 degree angle to the material, such as a straight cut that is at a 45-degree angle relative to an edge of a board.

When using a handheld saw, the user is typically responsible for guiding the saw in a straight line to make a straight cut. Making a straight cut with a handheld power saw can be difficult for a number of reasons including: difficulty seeing the material, lack of a guide line to follow, dust, sawdust, vibration from the saw, vibration from the cutting process, an awkward position from which the cut must be made, distractions, and/or a need to concentrate effort on pushing the saw through the material. These and other problems are solved by an optional or removable apparatus which helps a user make a straight cut with a handheld power saw, while not reducing the flexibility of the saw.

### SUMMARY

For the reasons discussed herein, there is a need for improved guides for use with handheld and/or portable power saws, such as circular saws, jigsaws, and other types of saws. The improved guides disclosed herein assist users of these types of saws in making straight and/or straighter cuts than the user be able to accomplish if operating the saw in a freehand fashion. The improved guides are adjustable, retractable, and/or removable in order to maintain the original flexibility of the saws.

In one example, a guide is provided for use with a handheld power saw having a baseplate and a moving blade that extends through an opening in the baseplate to an area under a plane of the baseplate. The blade is configured for cutting a piece of material by sliding the baseplate across a top surface of the material to drive the moving blade of the handheld power saw through the material. In this example, the guide includes an attachment mechanism and a guide pin. The attachment mechanism is configured or adapted for removably attaching the guide to a back edge of the baseplate of the handheld power saw. The guide is configured or adapted to attach to the baseplate proximate a cut made in the material when the handheld power saw is operated to make the cut in the material. The guide is removable from the baseplate when not in use. The guide pin is affixed to the attachment feature and configured or adapted to extend into the cutting area under the plane of the baseplate when the attachment feature of the guide is attached to the baseplate of the handheld power saw. The guide pin is further configured or adapted to be in a plane of the blade and extend at least partially into the cut in the material made by the blade when the handheld power saw is operated to make the cut in the material.

In another example, a guide for use with a portable power saw is provided. The power saw has a baseplate and a moving blade that extends through an opening in the baseplate to an area under a plane of the baseplate for cutting a piece of material. The guide includes a guide base configured to be attached to a back edge or tail end of the baseplate of the power saw on a top surface of the baseplate. The guide base is removable from the baseplate of the power saw. A guide pin is affixed to the guide base and configured to extend into a cutting area under the plane of the baseplate when the guide base is attached to the baseplate of the power saw. The guide pin is also positioned to be in a plane of the blade such that the guide pin extends at least partially into a cut or kerf made by the moving blade in the material when the guide base is attached to the baseplate of the power saw and the power saw is operated to make the kerf in the material.

In yet another example, a handheld cutting tool for making a straight cut in a piece of material includes a guide. The handheld cutting tool has a baseplate and a moving blade that extends through an opening in the baseplate to an area under a plane of the baseplate for cutting the material in the area under the plane of the baseplate. The guide is attached to the handheld cutting tool in a location such that the attached guide will be proximate the cut made in the material when the handheld cutting tool is operated to make the cut in the material. The guide includes a guide pin configured to extend into the area under the plane of the baseplate to be in a plane of the blade and configured to extend at least partially into the cut in the material made by the blade when the handheld cutting tool is operated to make the cut in the material.

Other variations and embodiments are possible, including variations and embodiments which do not necessarily include all of the elements described above and/or variations and embodiments which may include additional elements. The embodiments described in this disclosure have been chosen to explain the principles of the concept and its practical application to enable others skilled in the art to best utilize the invention. It is not intended that claims be limited to only these particular embodiments. It is intended that the claims be construed to include other alternative embodiments of the invention, except as limited by the prior art. Those skilled in the art will appreciate that various features or elements in the drawings may not necessarily be drawn to scale, and that dimensions or sizes of various features or elements may be expanded or reduced for illustration purposes. Those skilled in the art will also appreciate that various features or elements which may not be necessary for the explanation of a particular embodiment may be simplified and/or absent from one or more of the drawings.

### BRIEF DESCRIPTION OF THE DRAWINGS

Reference will now be made in detail to the representative embodiments illustrated in the drawings. The accompanying descriptions are not intended to limit the embodiments to one preferred embodiment. To the contrary, the descriptions are intended to cover alternatives, modifications, and equivalents as can be included within the spirit of the described embodiments as defined by the claims.

FIG. 1 illustrates a side view of a power saw with which the disclosed guides may be used;

FIG. 2 illustrates a side view of a power saw with a guide attached;

FIG. 3 illustrates a side view of the power saw with the guide cutting a piece of material;

FIG. 4 illustrates an overhead view of the power saw with the guide cutting a piece of material;

FIG. 5 illustrates a side view of the power saw with the guide cutting the piece of material;

FIG. 6 illustrates an overhead view of the power saw with the guide cutting the piece of material;

FIG. 7 illustrates the guide in a cut produced by a blade of the power saw;

FIG. 8 illustrates another view of the guide in the cut produced by the blade of the power saw;

FIG. 9 illustrates the power saw with a retractable guide;

FIG. 10 illustrates the power saw and the retractable guide of FIG. 10 with the guide pin retracted; and

FIG. 11 illustrates a power saw with a configurable guide.

### DETAILED DESCRIPTION

One of the benefits of handheld power saws is the flexibility with which material can be cut in place or on a job site without necessarily placing the material into a frame, into a guide, into a vise, into a jig, or onto a platform or table of another type of saw or cutting machine. Another benefit is that handheld saws are often used to make freeform or freehand cuts in which the user guides the saw through the material along a path he or she chooses. While these benefits are useful in number of circumstances, they also present challenges to the user. One challenge is the fact that a user often wishes to make a straight cut through a piece of material even through the handheld saw may have the flexibility to make curved or freeform cuts. When using a handheld power saw, the user is responsible for guiding the saw in a straight line to make a straight cut. Making a straight cut with a handheld power saw can be difficult for a number of reasons.

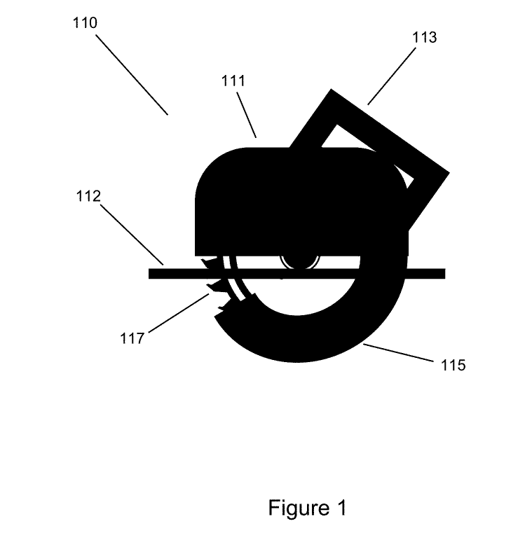

FIG. 1 illustrates a side view of a power saw 110 with which the guides disclosed herein may be used. Power saw 110 may be a circular saw. However, the improvements disclosed herein may be used with any type of handheld and/or portable saw including, but not limited to, a circular saw, a jigsaw, a reciprocating saw, and/or another type of handheld cutting tool having a baseplate. Power saw 110 includes a body 111, a baseplate 112, a handle 113, a blade 117, and a blade guard 115. Power saw 110 is described in general terms for purposes of describing the guides disclosed herein. Therefore, the description and illustrations of power saw 110 herein may not include all of the features or elements of a power saw with which the disclosed guides may be used.

Body 111 of power saw 110 may include a housing, structural features, a motor, a battery, a switch, and/or safety features of power saw 110. Handle 113 is used for carrying power saw 110 as well as for operating power saw 110 and moving power saw 110 through a piece of material for purposes of cutting the material. Power saw 110 also includes a blade 117 for cutting the material. Blade 117 is rotated by a motor or other mechanism. Blade guard 115 is a movable cover that covers at least a portion of blade 117 for safety purposes. Blade guard 115 is rotated or displaced to expose more of blade 117 as needed when a cut is taking place. Power saw 110 may include other elements such as a cord, a switch, a battery, a shield, and/or other components.

Power saw 110 also includes baseplate 112. When power saw 110 is used to cut a piece of material, baseplate 112 rests on a surface of the material as power saw 110 is pushed through the material. Blade 117 extends below baseplate 112 to extend into the material to make the cut. Baseplate 112 is often made of one or more metal materials, but may be made of one or more other materials. Baseplate 112 typically has a flat, planar surface that is used to slide across the surface of the material being cut. In the example of FIG. 1, the plane of baseplate extends into and out of the page.

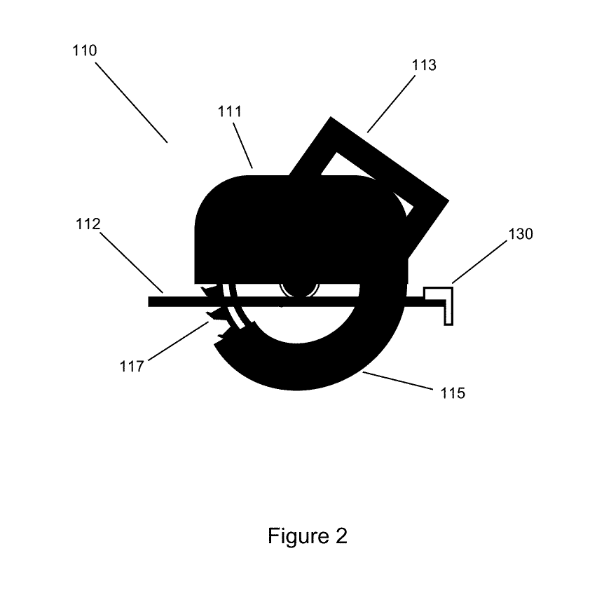

FIG. 2 illustrates a side view of power saw 110 of FIG. 1 with a guide 130 attached. Guide 130 is removably attached to a back end or tail end of baseplate 112. Guide 130 may be attached to baseplate 112 using any type of fastening mechanism including one or more of a screw, a snap, a clip, a spring-loaded mechanism, a spring clip, a friction device, a slot, a groove, a threaded fastener, a quick-release mechanism, hook and loop fastening material (such as VELCRO), and/or combinations thereof. The apparatuses and improvements disclosed herein are not to be limited to any particular attachment method or mechanism.

As illustrated in FIG. 2, guide 130 extends below the plane of baseplate 112 into an area that may be occupied by material when a cut is taking place. Guide 130 may be formed from one or more rigid materials including one or more of a metal, a plastic, a ceramic, or a combination thereof. Beneficially, guide 130 is removable from baseplate 112 when it is not in use. Beneficially, guide 130 may be attached to or removably affixed to baseplate 112 of power saw 110 in an aftermarket fashion. In other words, guide 130 may be attached or affixed to baseplate 112 of power saw 110 by an end user even though the original manufacturer of power saw 110 may not have included features for attaching guide 130 and/or envisioned attachment of guide 130.

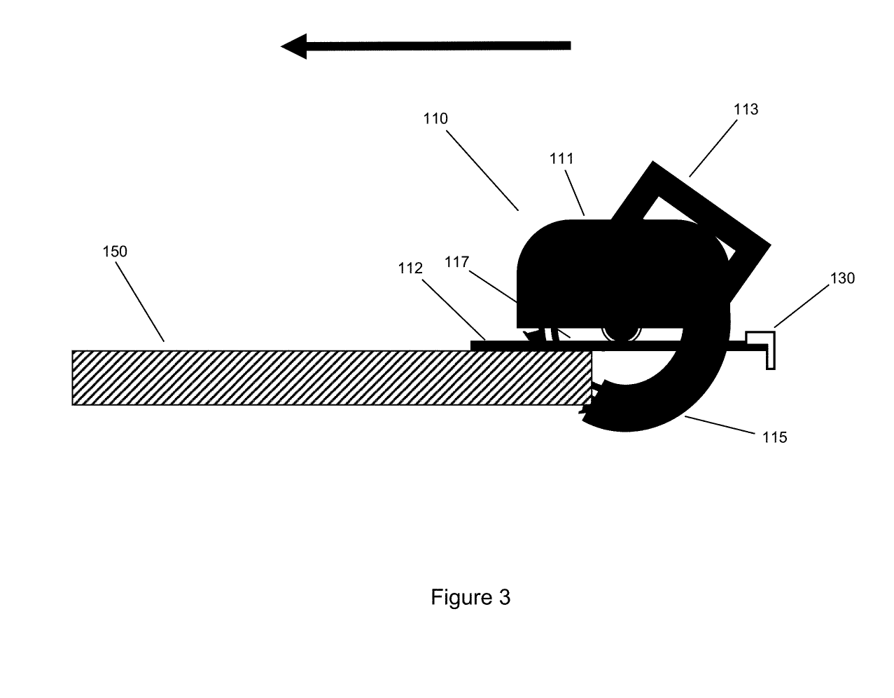

FIG. 3 illustrates a side view of power saw 110 with guide 130 while cutting a piece of material 150. Material 150 may be a piece of lumber, a piece of plywood, a piece of engineered material, or any other material capable of being cut by power saw 110 and blade 117. After rotation of blade 117 begins, power saw 110 is gradually pushed through material 150 using handle 113. Power saw 110 is gradually moved through material 150 in the direction of the arrow in FIG. 3. As the cut progresses, spring-loaded blade guard 115 is pushed farther back to expose more of blade 117. As the cut takes place, the weight of power saw 110 primarily rests on the top surface of material 150 through baseplate 112. Baseplate 112 is slid across the surface of material 150. The planar nature of baseplate 112 and the surface of material 150 maintain a preferred angular relationship between blade 117 and material 150.

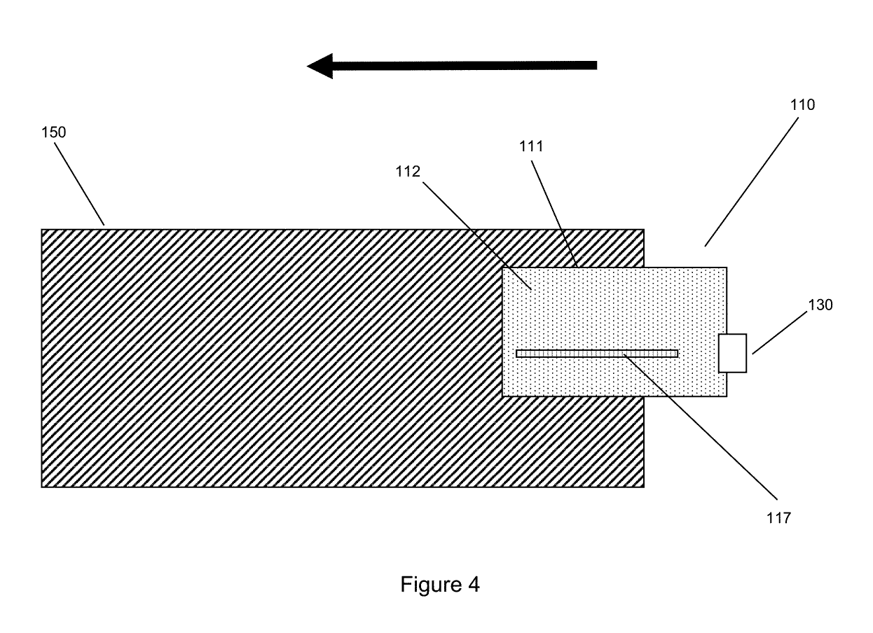

FIG. 4 illustrates an overhead view of the configuration of FIG. 3 in which power saw 110, with guide 130, is cutting material 150. Some details of power saw 110 and housing 111 are excluded from FIG. 4 for purposes of illustrating the orientation of blade 117. In this view, blade 117 is a substantially flat disk with teeth that extend through a slot in baseplate 112 into material 150. Blade 117 rotates to cut through material 150. Blade 117 cuts a narrow slot or path, also called a kerf, through material 150. The kerf is defined by the path that blade 117 takes through material 150. Guide 130 is attached to a tail, back end, or back edge of baseplate 112 behind blade 117.

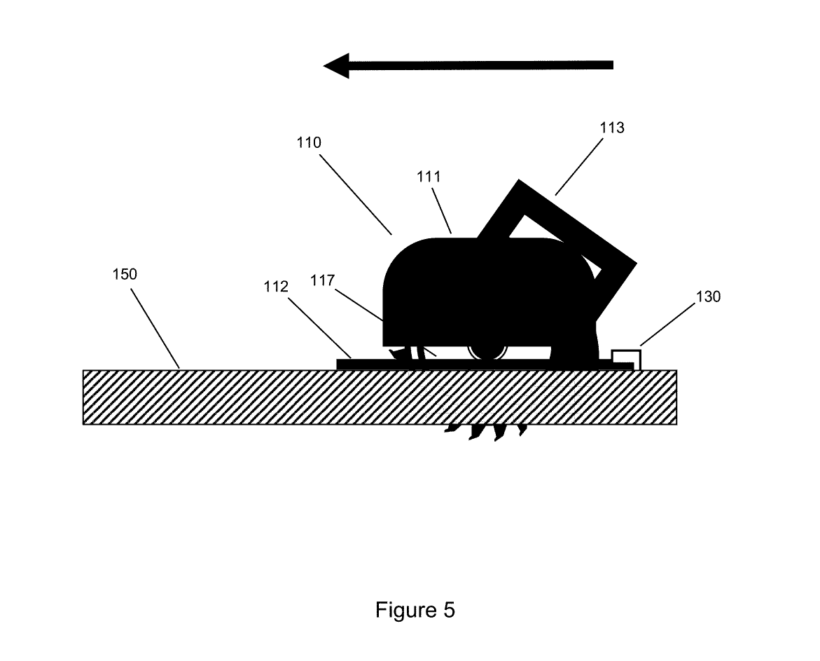

FIG. 5 illustrates a progression of FIG. 3 with power saw 110 further cutting material 150. At this stage, the trailing edge of blade 117 has entered the kerf formed by the leading edge of blade 117. Power saw 110 is progressing through the cut through the force of the user (not illustrated). At this stage, a portion of guide 130 also extends into the cut or kerf. Beneficially, the alignment of guide 130 with the plane of blade 117 causes power saw 110 to continue forward on a substantially straight cutting path. Without guide 130, power saw 110 has more opportunity or tendency to move, drift, or be pushed in a non-straight line. Guide 130 acts as a rudder to better maintain a straight, or substantially straight, direction of movement. This occurs because the portion of guide 130 extending into the kerf is in a plane of blade 117.

Guide 130 enables a user to produce a straighter cut and allows the user to focus more of his or her attention on other aspects of the cut, including safety. In some situations, the addition of guide 130 may provide enough of a straightening tendency that a user may be able to make a substantially straight cut without the additional effort of having to make a scribe or guide line across material 150 to follow.

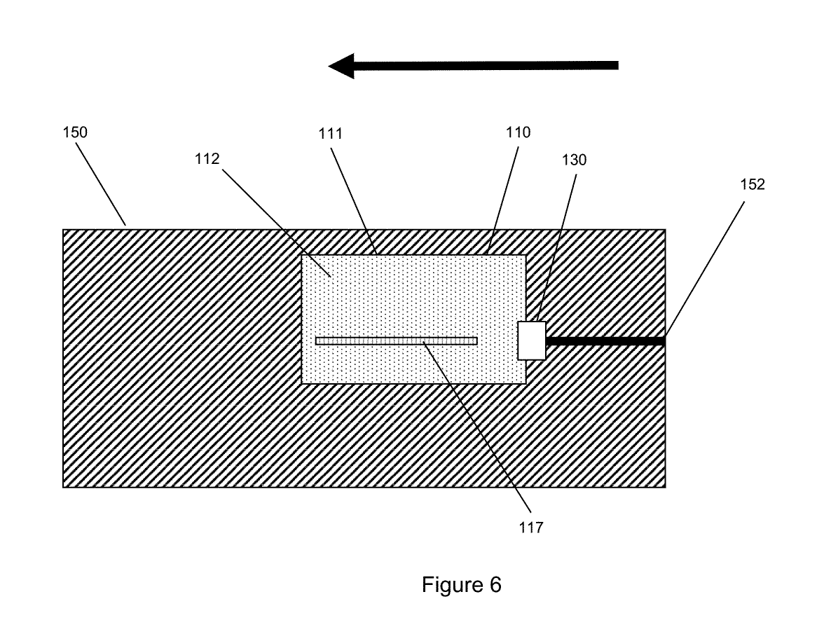

FIG. 6 illustrates an overhead view of the arrangement of FIG. 5 with power saw 110 further cutting material 150. FIG. 6 illustrates kerf 152 that has been cut through material 150 by blade 117 of power saw 110. Guide 130 is removably attached to base plate 112 such that it is aligned with a plane of blade 117 and extends into kerf 152 in a straight line aligned behind blade 117 as blade 117 cuts through material 150. The rudder effect of guide 130 extending in kerf 152 causes power saw to tend to stay on a straight, or substantially straight, path through material 150 because the guide prevents the power saw from being turned while the cut is taking place. This effect makes it much easier for the user of power saw 110 to continue a straight path through material 150 rather than veering off on a curved or irregular course.

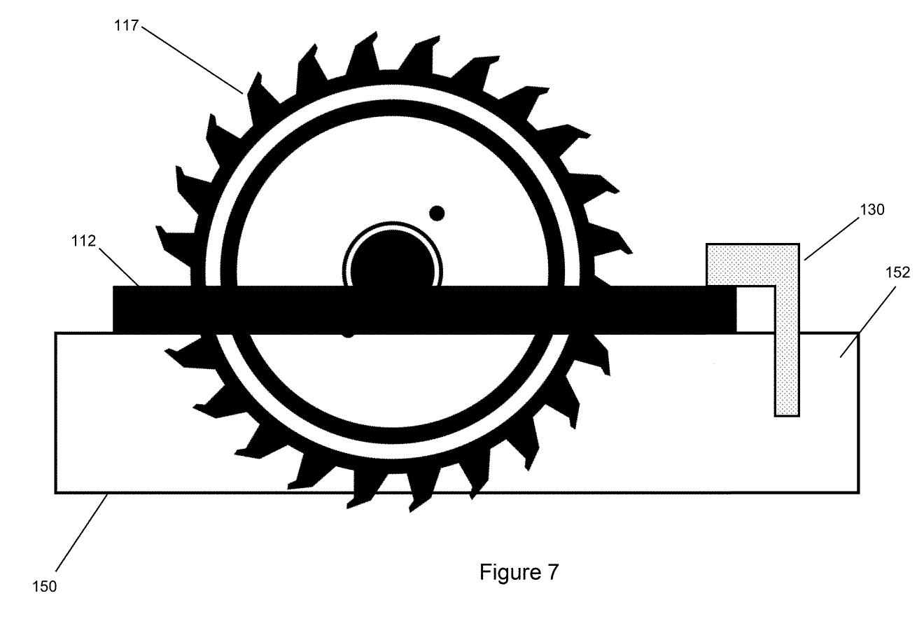

FIG. 7 illustrates a sectional view of blade 117 and guide 130 in kerf 152 produced by blade 117 while in the process of a cut. Other elements of power saw 110 are excluded from FIG. 7 for purposes of illustration. The sectional view of FIG. 7 thereby illustrates the movement of blade 117 and guide 130 through kerf 152 in material 150. Guide 130 trails blade 117 in the kerf and does so substantially in a plane of blade 117 to keep that path of power saw 110 through material 150 substantially straight. The portion of guide 130 extending into kerf 152 has a width that is slightly less than an expected width of kerf 152 such that it will slide through kerf 152 easily, but without much slop. Since the width of kerf 152 is primarily dictated by a width of blade 117, the width of the portion of guide 130 extending into kerf 152 may be selected based, at least in part, on the width of blade 117. Consequently, the portion of guide 130 extending into kerf 152 has a width that is the same or less than a width of blade 117. The width of guide 130 may be less than the width of the blade to allow it to easily slide through kerf 152 with minimal drag and/or to accommodate potential relaxation in material 150 that may cause kerf 152 to be slightly less than the width of blade 117.

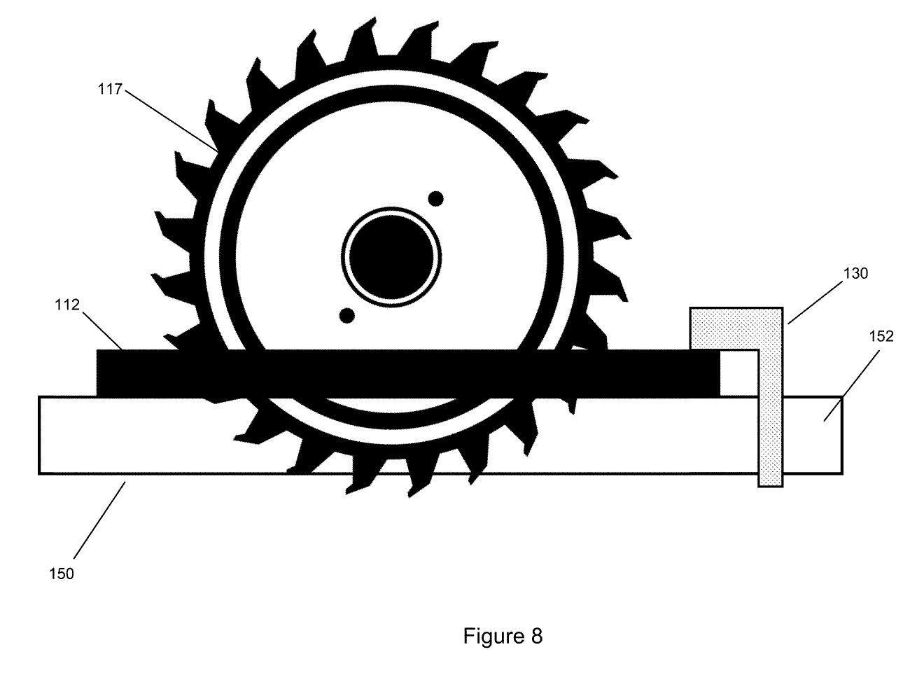

In the example of FIG. 7, the portion of guide 130 extending into kerf 152 has a length less than a thickness of material 150 such that the portion of guide 130 does not extend through to a bottom surface of material 150. In some situations, a shorter guide may be beneficial to reduce the chance of it catching or snagging on other items. In contrast, FIG. 8 illustrates a configuration in which the portion of guide 130 extending into kerf 152 has a length which is longer than a thickness of material 150 such that guide 130 extends past a bottom surface of material 150 while the cut is taking place. A longer guide may be beneficial in that it provides more stability and/or accommodates a wider range of material thicknesses.

While guide 130 is primarily illustrated in FIGS. 2-8 as a single piece apparatus, it should be understood that guide 130 may comprise two or more components, elements, members, or portions. In one example, guide 130 may comprise an attachment portion for attaching to a saw and a guide or guide pin portion for extending into the cut or kerf made by the power saw. In other examples, guide 130 may comprise three or more components, elements, members, or portions.

In one example, a prototype guide 130 was manufactured from an office supply spring clip, some hook and loop fastener material, and a nail. One portion of the hook and loop fastener was adhered to baseplate 112 while the other portion was adhered to the mouth of the spring clip. The nail was attached to the spring clip such that it will face downward when the spring clip is attached to the baseplate of the saw or to a lip of the baseplate of the saw (mimicking guide 130 of FIG. 3). The hook and loop fastener, along with the force of the spring clip, keeps the spring clip in place on the baseplate despite vibration and operation of the saw. When positioned correctly such that the nail is directly behind and/or in the plane of blade 117, the nail performs the guide function described with respect to any of FIGS. 2-11. In another prototype, the nail was substituted with a straight portion of saw blade. The potion of saw blade travels through the cut or kerf during a cut as a guide pin would.

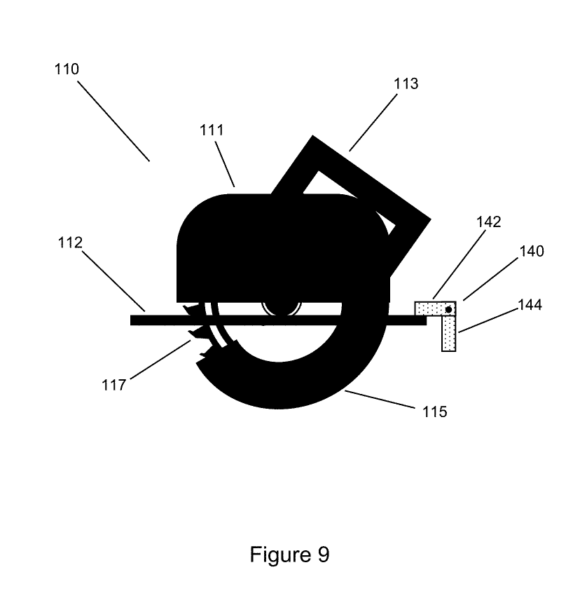

FIG. 9 illustrates power saw 110 with a retractable guide 140. Retractable guide 140 is an example of guide 130 described above. Retractable guide 140 may include any of the functions, features, elements, or characteristics of guide 130. Retractable guide 140 is a variation of guide 130 that allows guide 140 to be used selectively. Retractable guide 140 enables the user to easily configure power saw 110 for use with or without the guide, and without removing guide 140 from the saw. This allows the user to more quickly switch between modes of operation and also allows the user to switch modes of operation without having to realign the guide with blade 117.

Retractable guide 140 includes an attachment mechanism 142 and a guide pin 144. Attachment mechanism 142 may be attached to baseplate 112, or to a lip of baseplate 112, using any of the attachment components or techniques described above with respect to guide 130. Attachment mechanism 142 may be attached to baseplate 112 by an end user as an aftermarket product or may be attached by the original equipment manufacturer (OEM) of power saw 110. In some cases, attachment mechanism 142 may also be referred to as a base, a guide base, a base member, and/or an attachment member.

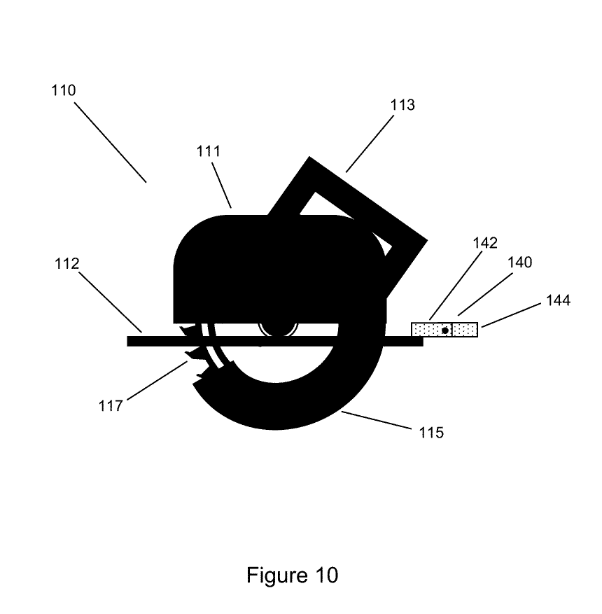

Guide pin 144 is hingedly or pivotably attached to attachment mechanism 142 such that guide pin 144 can be moved, pivoted, or rotated relative to attachment mechanism 142. FIG. 10 illustrates power saw 110 and retractable guide 140 of FIG. 9, but with guide pin 144 retracted. In this configuration, guide pin 144 does not engage or interact with the material being cut and/or a cut or kerf produced by power saw 110 in the material. This configuration enables power saw 110 to be used in the conventional or non-guided manner without having to completely remove retractable guide 140 from power saw 110 and/or baseplate 112. Guide pin 144 may pivot, rotate, retract, and/or be mechanically reconfigured in any way to temporarily move it out of the path of a cut or kerf produce by power saw 110. In this way, a user can quickly and easily switch power saw 110 between modes without having to fully remove retractable guide 140.

Retractable guide 140 may also have a locking mechanism, detent feature, and/or spring loaded mechanism to more positively, but still temporarily, keep guide pin 144 in either the operational position of FIG. 9 or the retracted position of FIG. 10 despite vibration and use of power saw 110. Other types of guide pin retraction are possible and the improvements, techniques, and apparatuses disclosed herein are not to be limited to the particular retraction technique illustrated in FIGS. 9 and 10.

In another example, a guide may comprise two or more components, like retractable guide 140, but may not necessarily be retractable like guide 130. In other words, guide 140 may not be retractable in some cases. In this example, attachment mechanism 142 may be configured for removably attaching to a back edge of baseplate 112 of handheld power saw 110, where guide 140 is configured to attach to baseplate 112 proximate a cut made in material when power saw 110 is operated to make the cut in the material. Guide 140 may still be removable from baseplate 112 when not in use. Guide pin 144 is affixed to attachment feature 142 and configured to extend into the area under the plane of baseplate 112 when attachment feature 142 of guide 140 is attached to baseplate 112 of power saw 110. Guide pin 144 is in a plane of blade 117 and extends at least partially into the cut in the material made by blade 117 when power saw 110 is operated to make the cut in the material. While guide pin 144 is described as a ‘pin,’ it may have any shape and/or any cross sectional shape.

Various instances of attachment feature 142 may have different dimensions or interface characteristics designed and chosen to fit to baseplates of various different makes or types of power saws. Different power saws may have differently shaped baseplate edges or lip designs. In some cases, an attachment feature 142 may be made to attach to a particular type or group of saws having a particular baseplate and lip design. In other cases, guide 140 may include another member that is designed to attach to the particular type or group of saws and also attach to a generic attachment feature 142. In other words, the apparatus may also include or be compatible with an adapter that adapts it to fit to various types of saws and/or baseplates.

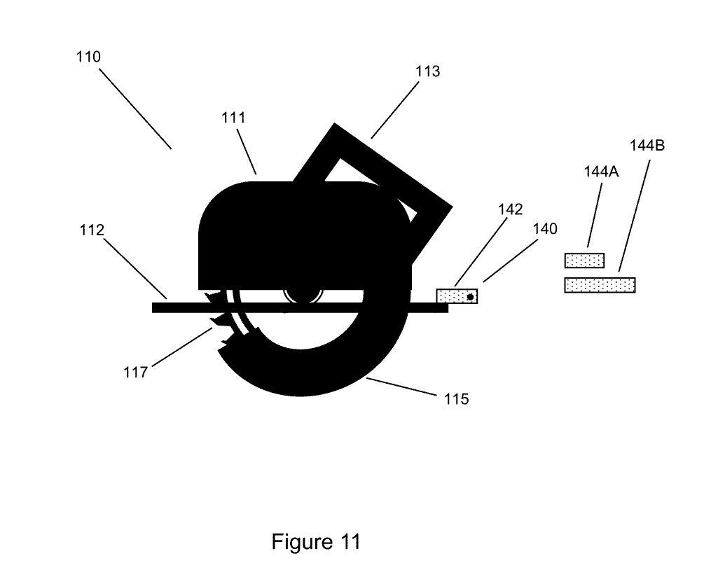

FIG. 11 illustrates power saw 110 with a variation of configurable guide 140. In FIG. 11, configurable guide 140 can be configured, or reconfigured, with guide pins of varying lengths and/or widths. Configurable guide 140 includes attachment mechanism 142. Any number of guide pins, such as guide pin 144A or guide pin 144B, may be selectively attached to or removed from configurable guide 140. The lengths and/or thickness of guide pin 144A or guide pin 144B may be selected based on the thickness of the material being cut, the type of material being cut, the thickness of blade 117, the type of blade 117, and/or other factors, including combinations thereof. In other words, guide pins of different sizes may be used without having to remove or replace attachment mechanism 142. Guide pins 144A and 144B may be both removable and retractable as discussed with respect to FIGS. 9 and 10.

In yet another variation, the guide or guide pin may be adjustable from side to side to different angles relative to the plane of the baseplate. This adjustment accommodates saws in which the blade may be adjusted to an angle relative to the baseplate. This adjustment of the pin allows the guide function disclosed herein to be accomplished even though if the blade is not perpendicular to the baseplate.

In some cases, the apparatuses disclosed herein may be provided in the form of a system or kit which includes power saw 110 and at least one of guide 130 or retractable guide 140. In these cases, baseplate 112 may be designed and manufactured with attachment points or features for guide 130 and/or attachment feature 142. In other cases, baseplate 112 may be manufactured with guide 130 or attachment feature 142 permanently affixed to baseplate 112. Further, additional guide pins of varying lengths, thicknesses, and/or materials may be sold individually or as sets. The system or kit may include any combination of the techniques, improvements, devices, components, features, functions, and/or processes disclosed herein.

The apparatuses, techniques, improvements, devices, components, features, functions, and/or processes described herein are meant to exemplify some types of possibilities. In no way should the various examples provided herein limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

This disclosure is presented for purposes of illustration and description. Other modifications and variations may be possible in view of the above teachings. The embodiments described in this disclosure were chosen to explain the principles of the concept and its practical application to enable others skilled in the art to best utilize the invention. It is intended that the claims be construed to include other alternative embodiments of the invention except as limited by the prior art.

What is claimed is:

1. A guide for use with a handheld power saw, the handheld power saw having a baseplate and a moving blade that extends through an opening in the baseplate to an area under a plane of the baseplate for cutting a piece of material by sliding the baseplate across a top surface of the material to drive the moving blade of the handheld power saw through the material, the guide comprising:
an attachment mechanism configured for removably attaching the guide to a back edge of the baseplate of the handheld power saw, wherein the guide is configured to attach to the baseplate proximate a cut made in the material when the handheld power saw is operated to make the cut in the material, and wherein the guide is removable from the baseplate when not in use; and
a guide pin affixed to the attachment feature and configured to extend into the area under the plane of the baseplate when the attachment feature of the guide is attached to the baseplate of the handheld power saw, the guide pin further configured to be in a plane of the blade and extend at least partially into the cut in the material made by the blade when the handheld power saw is operated to make the cut in the material.

2. The guide of claim 1 wherein the guide pin has a width that is less than a width of the blade of the handheld power saw.

3. The guide of claim 1 wherein the guide pin has length that is greater than a thickness such that the guide pin extends through the cut at least to an opposing side of the material.

4. The guide of claim 1 wherein the guide pin is affixed to the attachment feature with a pivot mechanism that enables the guide pin to be reversibly pivoted out of the area under the plane of the baseplate while the guide remains attached to the baseplate.

5. The guide of claim 1 wherein the handheld power saw is a handheld circular saw.

6. The guide of claim 1 wherein the handheld power saw is a portable jigsaw.

7. The guide of claim 1 wherein the attachment feature is configured to removably attach to the baseplate using one or more of a hook and loop fastener, a spring clip, a threaded fastener, a snap, a snap fastener, a spring loaded fastener, and a spring loaded attachment mechanism.

8. The guide of claim 1 wherein the attachment feature includes a first portion and a second portion, wherein the first portion remains attached to the baseplate of the handheld power saw when the guide is removed and wherein the second portion of the attachment feature attaches to the first portion of the attachment feature when the guide is removably attached to the baseplate of the handheld power saw.

9. The guide of claim 1 wherein the guide pin is removably affixed to the attachment feature.

10. The guide of claim 9 further including a second guide pin have a size that is different than a size of the guide pin, wherein the second guide pin is configured to be removably affixed to the attachment feature when the guide pin is removed from the attachment feature.

11. A guide for use with a portable power saw, the power saw having a baseplate and a moving blade that extends through an opening in the baseplate to an area under a plane of the baseplate for cutting a piece of material, the guide comprising:
a guide base configured to be attached to a back edge of the baseplate of the power saw on a top surface of the baseplate, wherein the guide base is removable from the baseplate of the power saw; and
a guide pin affixed to the guide base and configured to extend into a cutting area under the plane of the baseplate when the guide base is attached to the baseplate of the power saw, the guide pin positioned to be in a plane of the blade such that the guide pin extends at least partially into a kerf made by the moving blade in the material when the guide base is attached to the baseplate of the power saw and when the power saw is operated to make the kerf in the material.

12. The guide of claim 11 wherein the guide base is configured to removably attach to the baseplate using one or more of a hook and loop fastener, a spring clip, a threaded fastener, a snap, a snap fastener, a spring loaded fastener, and a spring loaded attachment mechanism.

13. The guide of claim 11 wherein the guide base includes a first portion and a second portion, wherein the first portion remains attached to the baseplate of the power saw when the guide is removed and wherein the second portion of the attachment feature attaches to the first portion of the guide case when the guide is removably attached to the baseplate of the power saw.

14. The guide of claim 11 wherein the guide pin is removably affixed to the guide base.

15. The guide of claim 11 further including a second guide pin have a size that is different than a size of the guide pin, wherein the second guide pin is configured to be removably affixed to the guide base when the guide pin is removed from the attachment feature.

16. The guide of claim 11 wherein the guide base is further configured to be removably attached to a second power saw when the guide is not attached to the power saw.

17. A handheld cutting tool for making a straight cut in a piece of material, the handheld cutting tool comprising:
a handheld power saw having a baseplate and a moving blade that extends through an opening in the baseplate to an area under a plane of the baseplate for cutting the material in the area under the plane of the baseplate; and
a guide attached to the handheld power saw in a location such that the attached guide will be proximate the cut made in the material when the handheld power saw is operated to make the cut in the material, the guide having a guide pin configured to extend into the area under the plane of the baseplate, the guide pin further configured to be in a plane of the blade and extend at least partially into the cut in the material made by the blade when the handheld power saw is operated to make the cut in the material.

18. The handheld cutting tool of claim 17 wherein at least one of the guide and the guide pin is removable from the baseplate.

19. The handheld cutting tool of claim 17 wherein the guide pin is pivotable to a second position in which the guide pin does not extend into the area under the plane of the baseplate.

20. The cutting tool of claim 17 wherein the guide pin is configured to extend away from the baseplate in one of the plane of the baseplate and a plane parallel to the baseplate to increase a distance between the guide pin and the blade.
